(19) United States
(12) Patent Application Publication
(10) Pub. No.: US 2008/0056794 A1
(43) Pub. Date: Mar. 6, 2008

(54) RIBBON CASSETTE AND PRINTER USING THE RIBBON CASSETTE

(75) Inventor: Kiyotaka Nihashi, Mishima (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: TOSHIBA TEC KABUSHIKI KAISHA, Tokyo (JP)

(21) Appl. No.: 11/468,855

(22) Filed: Aug. 31, 2006

(51) Int. Cl. B41J 31/16

(52) U.S. Cl. 400/202.1

(57) ABSTRACT

A ribbon cassette of the invention accommodates a driving mechanism configured to move an ink ribbon in a length direction using a driving roller and a driven roller, and an ink replenishing mechanism having a roller-shaped ink tank impregnated with ink and a transfer roller that comes into contact with an outer circumference of the ink tank and configured to replenish the ink ribbon with the ink soaked through the ink tank via the transfer roller inside a case. On an outer surface of the case at a portion opposing the ink tank, a tank cover portion is formed to swell in a figure similar to a figure of the ink tank, while an operation knob is disposed with an interval large enough to enable an operation of the knob from an outer circumference of the tank cover portion and linked to the driving roller disposed within the case.

### BACKGROUND OF THE INVENTION

1. Field of the Invention

The present invention relates to a ribbon cassette furnished with an ink replenishing function for an ink ribbon and a printer using the ribbon cassette.

2. Description of the Related Art

A wire dot method has been used widely as a method of printing arbitrary characters and figures on a medium subject to printing, such as a sheet of paper. According to the wire dot method, the medium subject to printing is disposed in a space between the print head and the platen. An ink ribbon impregnated with ink is also disposed in a space between the print head and the print medium. In performing the printing, a wire called a needle is activated to protrude from the print head while a carrier onto which is mounted the print head is moved along the platen, so that dot-shaped printing is performed on the print medium by causing the tip end of the needle to collide on the surface of the print medium via the ink ribbon.

The ink ribbon is of an endless shape and it forms a ribbon cassette by being accommodated in a case provided with an ink replenishing mechanism. The ribbon cassette is mounted on the carrier together with the print head, and disposed for part of the endless ink ribbon to oppose the print head. It is configured in such a manner that the endless ink ribbon is circulated to move in the length direction in association with the movements of the carrier for a new ink ribbon surface to oppose the print head.

The invention related to such a ribbon cassette is disclosed, for example, in JP-UM-A-6-42197, JP-A-5-16506, and so forth.

FIG. 1 shows the outward appearance of such a ribbon cassette 10, and components thereof are, as is shown in FIG. 2, accommodated in a lower portion case 11 having an open top surface. The lower portion case 11 has a main body portion 11a and a pair of arm portions 11b and 11c that respectively extend substantially in the shape of a circular arc from the both ends of one side of the case main body 11a. A space between the tip ends of this pair of arm portions 11a and 11b defines a print portion 10a (shown in FIG. 1) opposing an unillustrated print head. The pair of arm portions 11a and 11b therefore functions as inbound and outbound paths for an endless ink ribbon 12 to be circulated to move with respect to the print portion 10a. In addition, a driving mechanism 13 that feeds the endless ink ribbon 12 in the length direction to be circulated to move in association with movements of the carrier, and an ink replenishing mechanism 14 for the ink ribbon 12 are provided within the case main body 11a. The ink replenishing mechanism 14 replenishes a post-printing portion of the ink ribbon 12 having returned from the print portion 10a by passing through the arm portion 11c (the outbound path in circulation movements) through circulation movements of the ink ribbon 12 by the feeding operation of the driving mechanism 13 with ink.

The driving mechanism 13 has a driving roller 13a and a driven roller 13b that together nip the ink ribbon 12. The driving roller 13a rotates in a clockwise direction in the drawing in association with movements of the carrier to feed the ink ribbon 12 to the left in the drawing. The ink replenishing mechanism 14 has a roller-shaped ink tank 15. The ink tank 15 is shaped like a cylindrical column made of a sponge material or the like impregnated with ink, and is configured to be rotatable about the center of axis. The outer circumferential surface of a transfer roller 16 comes into contact with the outer circumferential surface of the ink tank 15, and this contact relation allows the ink tank 15 and the transfer roller to rotate in cooperation with each other. Further, a portion of the endless ink ribbon 12 having returned from the print portion 10a is stretched over the outer circumference of the transfer roller 16 to come into contact therewith. The transfer roller 16 therefore replenishes the contact portion (post-printing portion) of the ink ribbon 12 with ink by transferring the ink soaked through the ink tank 15. In this manner, the ink ribbon 12 replenished with ink is temporarily accommodated within a ribbon accommodation portion 17. Thereafter, the ink ribbon 12 is fed to the print portion 10a by passing through one arm portion 11b (the inbound path in circulation movements) as the driving roller 13a rotates in a clockwise direction in the drawing in association with the movements of the carrier.

The ribbon cassette 10 has an upper portion case 18 shown in FIG. 1 corresponding to the lower potion case 11 to cover the components accommodated in the interior thereof. The upper portion case 18 also has a main body portion 18a and a pair of arm portions 18b and 18c to correspond to the lower portion case 11. A tank cover portion 18d corresponding to the ink tank 15 accommodated inside and a shaft cover portion 18e corresponding to the driving roller 13a are formed on the top surface the main body portion 18a.

The driving roller 13a is used also to take up (wind up) the slack in the ink ribbon 12. For example, in a case where the slack occurs in the ink ribbon 12 when the ribbon cassette 10 is attached to the carrier, the slack is taken up by feeding the ribbon 12 in the length direction through manual rotational operations. In short, the driving roller 13a serves also as the take-up shaft to take up the slack in the ink ribbon 12. For this reason, as is shown in FIG. 1, an operation knob 19 is provided on the top of the shaft of the driving roller 13a.

The ink tank 15 in the related has a large diameter to increase a capacity (volume) of soaked ink. As is shown in FIG. 2, the ink ribbon 12 is therefore disposed to go along the outer circumference of the ink tank 15, which essentially requires the driving roller 13a to be provided near the outer circumference of the ink tank 15.

As is shown in FIG. 1, the tank cover portion 18d and the shaft cover portion 18e provided on the top surface of the upper portion case 18 are in extremely close proximity to each other, and they are substantially made into one unit. This positional relation makes it impossible to operate the operation knob 19 provided on the top of the driving roller 13a unless it is provided to protrude above the top surface of tank cover 18d. It is thus necessary to secure a space comparable to the height of the operation knob 19 from the top surface above the tank cover 18d.

Generally, many components, such as the printed circuit board, are packaged densely in the interior of the printer into which the ribbon cassette 10 is provided. Securing such a space above the ribbon cassette 10 that moves by being mounted on the carrier is therefore a considerable waste in terms of efficient use of a space. The height in the axial direction may be increased as a countermeasure to increase the capacity of the ink tank 15. Increasing the height of the ink tank 15 in the axial direction, however, generates a considerable waste of the space for the reason described above, and is therefore almost infeasible in practice. In view of the foregoing, a need to increase the capacity of the ink tank 15 has not been addressed appropriately.

Even when one succeeds in increasing the height of the ink tank 15 in the axial direction, it is still necessary to dispose the operation knob 19 above the ink tank 15. This extends the axial length of the driving roller 13a onto which the operation knob 19 is attached. This readily gives rise to side-to-side swing in the shaft of the driving roller 13a, which may possibly cause a trouble in driving the ink ribbon 12.

### SUMMARY OF THE INVENTION

An object of the invention is therefore to provide a ribbon cassette that achieves an increased capacity of soaked ink by increasing the height of the ink tank in the axial direction without being affected by the presence of the operation knob, and a printer using the ribbon cassette.

According to one aspect of the invention, a ribbon cassette includes: a driving mechanism configured to nip an ink ribbon using a driving roller and a driven roller to move the ink ribbon in a length direction through rotations of the rollers; an ink replenishing mechanism having a roller-shaped ink tank impregnated with ink and a transfer roller that comes into contact with an outer circumference of the ink tank and configured to replenish the ink ribbon coming into contact with the transfer roller with the ink soaked through the ink tank via the transfer roller; a case configured to cover the driving mechanism and the ink replenishing mechanism and provided with a tank cover portion formed at a portion opposing the ink tank to swell in a similar figure; and a take-up operation knob provided on an outer surface of the case with an interval large enough to enable an operation of the knob from an outer circumference of the tank cover portion and linked to the driving roller disposed within the case by penetrating through the case.

Further, according to another aspect of the invention, a printer includes: a ribbon cassette accommodating a driving mechanism configured to move an ink ribbon in a length direction and an ink replenishing mechanism having a roller-shaped ink tank impregnated with ink and a transfer roller that comes into contact with an outer circumference of the ink tank and configured to replenish the ink ribbon with the ink soaked through the ink tank via the transfer roller inside a case, a tank cover portion being formed on the case at a portion opposing the ink tank to swell in a similar figure, and a take-up operation knob being provided on an outer surface of the case with an interval large enough to enable an operation of the knob from an outer circumference of the tank cover portion and linked to the driving roller disposed within the case by penetrating through the case; a carrier on which are mounted a print head to oppose a platen fixedly provided along a specific printing direction and the ribbon cassette for part of the ink ribbon to be positioned in a space between the print head and the platen, and which is configured to be able to reciprocate along a length direction of the platen; and a medium feeding mechanism configured to feed a medium subject to printing into a space between the platen and the ink ribbon as well as the print head and then to move the medium in a direction orthogonal to a moving direction of the carrier in association with a movement of the carrier.

### BRIEF DESCRIPTION OF THE DRAWINGS

FIG. 1 is a perspective view used to describe a ribbon cassette in the related art;

FIG. 2 is a plan view showing part of the internal configuration of the ribbon cassette in the related art;

FIG. 3 is a perspective view showing the outward shape of a ribbon cassette according to a first embodiment of the invention;

FIG. 4 is a plan view showing the internal configuration of the ribbon cassette according to the first embodiment of the invention;

FIG. 5 is a perspective view showing the outward shape of a printer using the ribbon cassette according to the first embodiment of the invention; and

FIG. 6 is a perspective view showing the internal configuration of the printer using the ribbon cassette according to the first embodiment of the invention.

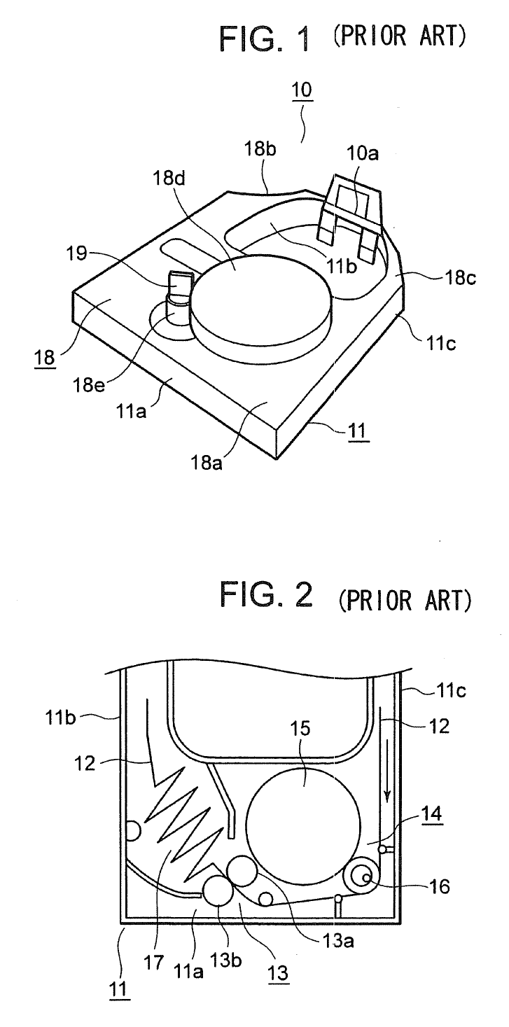

### DETAILED DESCRIPTION OF THE INVENTION

Hereinafter, one embodiment of the invention will be described in detail with reference to the accompanying drawings.

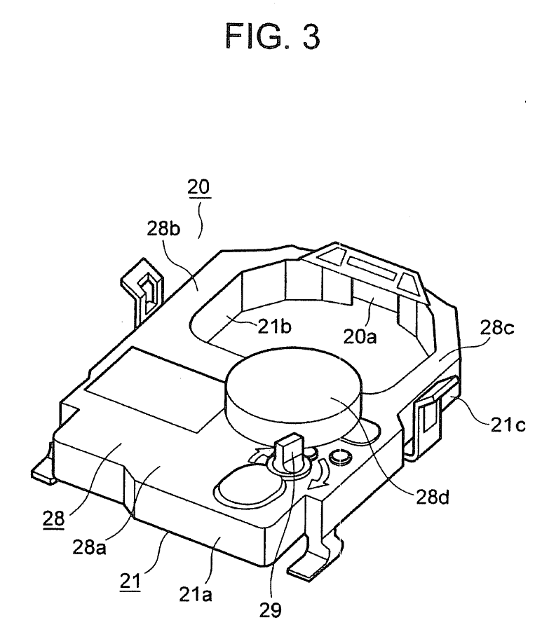

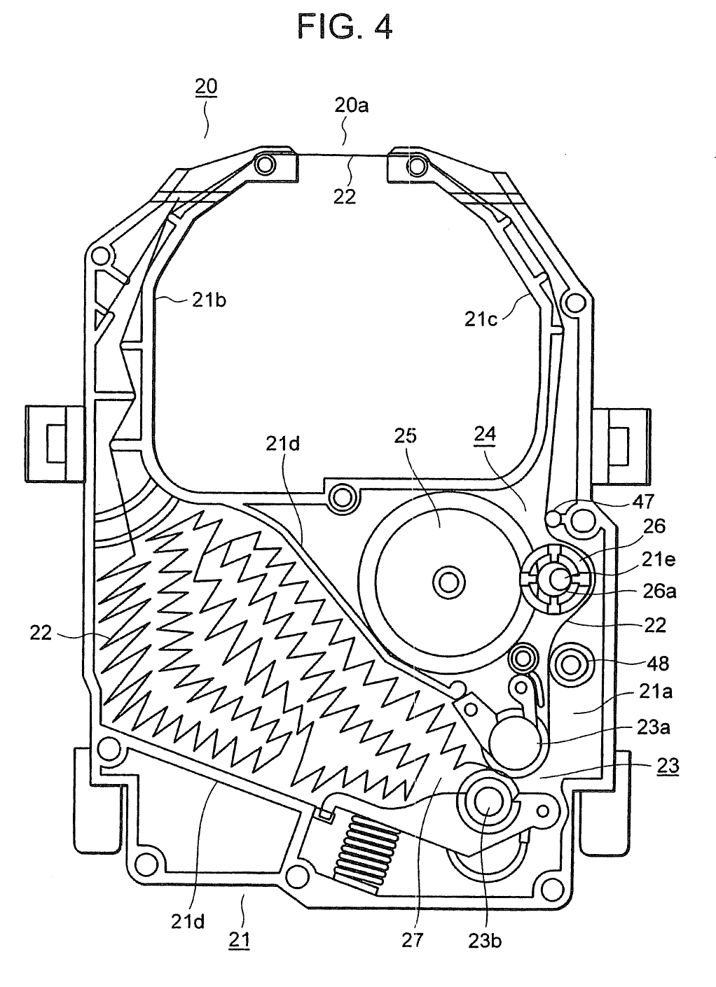

FIG. 3 shows the outward appearance of a ribbon cassette 20 according to a first embodiment of the invention, and FIG. 4 shows the internal configuration thereof. As is shown in FIG. 4, the components forming the interior of the ribbon cassette 20 are formed to be disposed in the interior of a lower portion case 21 having an open top surface, and as is shown in FIG. 3, the top surface thereof is covered with an upper portion case 28. These cases 21 and 28 respectively have main body portions 21a and 28a and a pair of arm portions 21b and 21c and a pair of arm portions 28b and 28c that extend substantially in the shape of a circular arc, respectively, from the both ends of the upper sides of the main body portions 21a and 28a in the drawing. Spaces between the tip ends of these pair of the arm portions 21b and 21c and pair of arm portions 28b and 28c define a print portion 20a that opposes the print head described below.

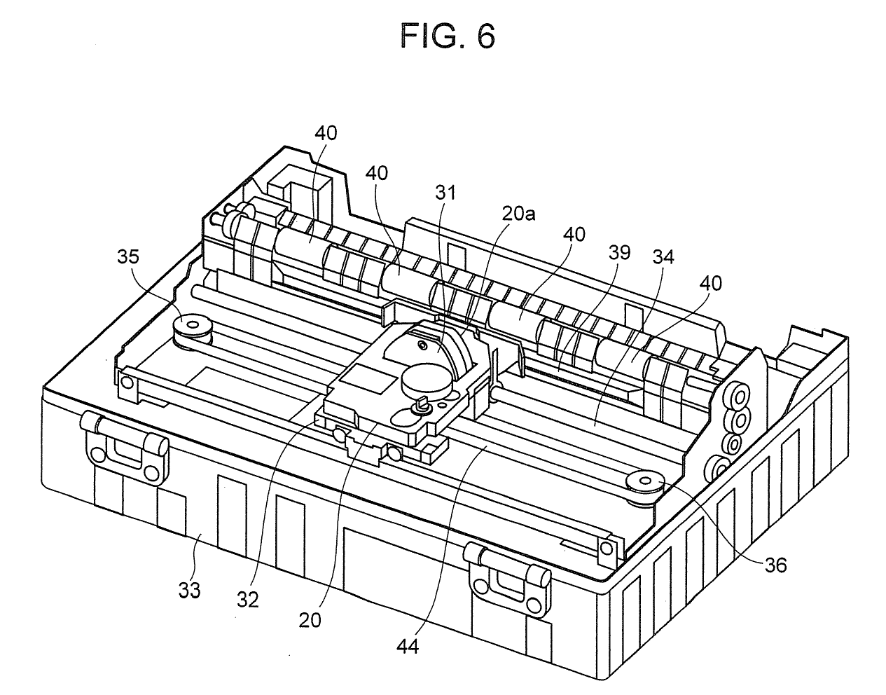

For application to a printer, as is shown in FIG. 6, the ribbon cassette 20 is attached to a carrier 32 on which a print head 31 of the wire dot method is mounted. To be more specific, the ribbon cassette 20 is attached to the carrier 32 in such a manner that the pair of arm portions 21b and 21c and the pair of arm portions 28b and 28c surround the print head 31, and that the print portion 20a defined by the space between the tip ends of these pair of arm portions 21b and 21c and pair of the arm portions 28b and 28c opposes the portion of the print head 31 from which a wire called a needle protrudes. In the ribbon cassette 20, an endless ink ribbon 22 accommodated inside and described below is circulated to move to the print portion 20a.

As is shown in FIG. 6, the carrier 32 is supported on a guiding rod 34 disposed in the lateral direction in the drawing to be allowed to reciprocate within a lower portion case 33 of the printer. The carrier 32 is driven along the guiding rod 34 by a driving mechanism comprising a pair of pulleys 35 and 36 disposed on the left and right and a timing belt 37 stretched across these pulleys in association with the printing operation described below. In addition, a platen 39 is provided fixedly inside the lower portion case 33 at the position opposing the print head 31 mounted onto the carrier 32. The platen 39 is formed horizontally long in order to cover the print range of the print head 31 in association with the movements of the carrier 32.

Although it is not shown in the drawing, a roller that supplies a medium subject to printing (a sheet of paper or the like) into a space between the platen 39 and the print head 31 is provided below the platen 39. This supply roller forms a medium feeding mechanism together with a discharging roller 40 disposed above the platen 39.

As has been described, the print head 31 is mounted on the carrier 32 and opposes the platen fixedly disposed along a specific printing direction. Also, the ribbon cassette 20 is attached to the carrier 32 in such a manner that part of the ink ribbon 22 (portion positioned at the print portion 20a) is positioned in a space between the print head 31 and the platen 39. Further, the medium feeding mechanism having the discharge roller 40 supplies a medium subject to printing in a space between the platen 39 and the ink ribbon 22 as well as the print head 31, and moves the medium in a direction orthogonal to the moving direction of the carrier in association with the movements of the carrier 32.

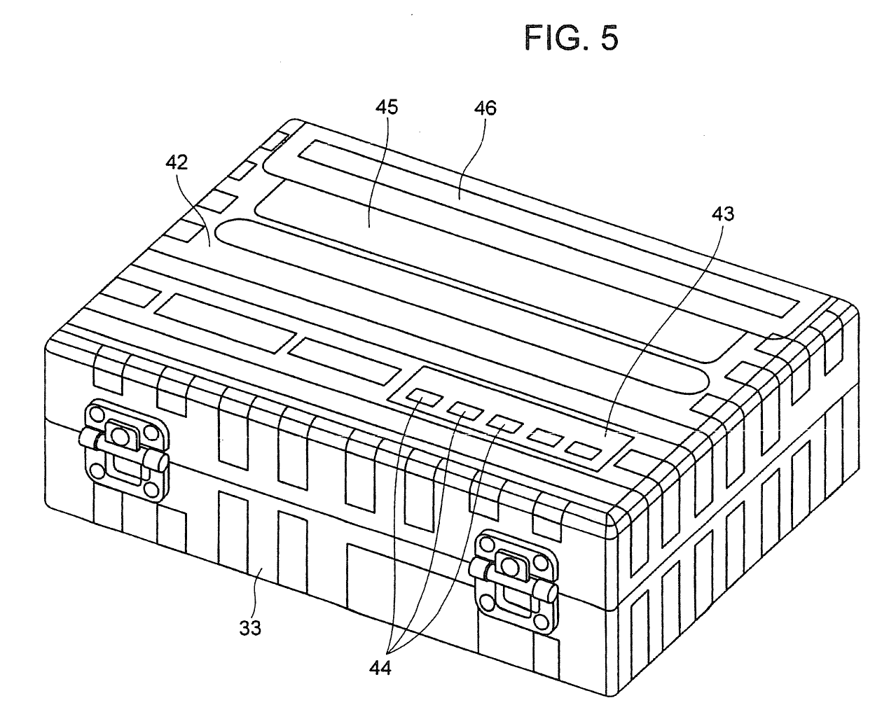

As is shown in FIG. 5, an upper portion case 42 is provided in an openable and closable manner to correspond to the lower portion case 33 of the printer. Various control components, such as the printed circuit board, used to control the respective portions of the printer are provided inside the upper portion case 42. In addition, an operation portion 43 is disposed on the top surface of the upper portion case 42 on the top surface the front side in the drawing, and it is provided with plural switches 44 used to input various control instructions. Further, an insert portion of a medium subject to printing and a discharge portion of a printed medium are provided on the top surface portion of the upper portion case 42.

A medium, such as a sheet of paper, is fed into a space between the print head 31 and the platen 39 by the medium feeding mechanism. Also, the print portion 20a of the ribbon cassette 20 is positioned in a space between the print head 31 and the print medium. A portion of the ink ribbon 22 impregnated with ink is supplied to the print portion 20a. In performing the printing, the print head 31 is activated, so that a wire called a needle is activated to protrude. The tip end of the wire activated to protrude collides on the surface of the medium via the ink ribbon 22. Dot-shaped printing is thus performed on the medium. Arbitrary characters and figures are drawn on the medium by moving the carrier 32 along the platen 34 in association with the operations of the print head 31.

The detailed configuration of the ribbon cassette 20 described above will now be described. Referring to FIG. 4, the pair of arm portions 21b and 21c of the lower portion case 21 functions as inbound and outbound paths for the endless ink ribbon 22 to be circulated to move with respect to the print portion 20a. A driving mechanism 23 that feeds the endless ink ribbon 22 in the length direction in association with the movements of the carrier 32 and an ink replenishing mechanism 24 for the ink ribbon 22 are provided inside the main body portion 21a of the lower portion case 21. The ink replenishing portion 24 replenishes the post-printing portion of the ink ribbon 22 having returned from the print portion 20a by passing through the arm portion 21c (the outbound path) through the feeding operation of the driving mechanism 23 with ink.

The ink ribbon 22 is of an endless shape, and the length thereof is sufficiently longer than the length of the circulation path of the ribbon comprising the case main body portion 21a and the pair of arm portions 21b and 21c. Most of the ink ribbon 22 is therefore accommodated in a folded state within a ribbon accommodation chamber 27 defined by a partition wall 21d inside the case main body 21a as is shown in the drawing.

The ink replenishing mechanism 24 has a roller-shaped ink tank 25. The ink tank 25 is shaped like a cylindrical column made of a sponge material or the like impregnated with ink, and it is formed to be rotatable in the shape of a roller. It is preferable for the ink tank 25 to have a larger ink capacity, and there has been a need to increase the volume thereof. To address this need, the ink capacity is increased in this embodiment not by increasing the diameter of the cylindrical column as in the related art, but by increasing the height in the axial direction.

The ink tank 25 is provided in a rotatable manner inside the lower portion case 21a in an upper right portion of FIG. 4, that is, in a portion in close proximity to the outbound path of the ink ribbon 22 from the print portion 20a near the root of the arm portion 21c. A transfer roller 26 is provided in a rotatable manner on the right side of the ink tank 25 in the drawing. The outer circumferential surface thereof comes into contact with the outer circumferential surface of the ink tank 25. In the outer circumferential portion of the transfer roller 26 on the right in the drawing, the ink ribbon 22 is guided by guiding members 47 and 48 disposed above and below the ink ribbon 22 to come into contact with the transfer roller 26. The contact portion (post-printing portion) of the ink ribbon 22 is thus replenished with ink soaked through the ink tank 25 by being transferred by the transfer roller 26. The inner circumference 26a of the axial core portion of the transfer roller 26 is loosely fit in a supporting shaft 21e on the case side. The center of rotation of the transfer roller 26 is therefore allowed to undergo displacement in the horizontal direction in the drawing, and it is configured in such a manner so as to change a contact pressure against the ink tank 25.

The driving mechanism 23 has a driving roller 23a and a driven roller 23b that together nip the ink ribbon 22. The driving roller 23a is configured to rotate in a clockwise direction in the drawing in association with the movements of the carrier 32, and feeds the ink ribbon 22 into the ribbon accommodation chamber 27 on the left in the drawing through these clockwise rotations.

The driving roller 23a is disposed below the ink tank 25 and the portion of the ink ribbon 22 coming into contact with the transfer roller 26 is stretched over the driving roller 23a, and thereby feeds the ink ribbon 22 replenished with ink into the ribbon accommodation chamber 27 through the clockwise rotations in the drawing together with the driven roller 23b. Also, the driving roller 23a is disposed with a sufficient distance from the outer circumferential surface of the ink tank 25, and the distance will be described below.

As is shown in FIG. 3, the upper portion case 28 is provided to correspond to the lower portion case 21 that accommodates the respective components to cover these components accommodated inside. As has been described, the upper portion case 28 also has the main body portion 28a and the pair of arm portions 28b and 28c to correspond to the lower portion case 21. A tank cover portion 28d corresponding to the ink tank 25 packaged inside is formed on the top surface of the main body portion 28a.

The driving roller 23a is used also as a take-up shaft that takes up the slack occurred in the ink ribbon 22. For this reason, as is shown in FIG. 3, an operation knob 29 is provided on the top of the shaft of the driving roller 23a. The operation knob 29 is provided to stand upright on the top surface of the main body portion 28a of the upper portion case 28 to enable rotational operations.

As has been described, because the driving roller 23a is disposed with a sufficient distance from the outer circumferential surface of the ink tank 25, the operation knob 29 is naturally positioned with a sufficient distance from the outer circumferential surface of the tank cover portion 28d. Hence, unlike the related art, there is no need to provide the operation knob 29 to be higher than the top surface of the tank cover portion 28d, and as is shown in FIG. 3, it can be directly provided to stand upright on the top surface of the case main body portion 28a. A distance from the driving roller 23a to the outer circumferential surface of the ink tank 25 is therefore defined as a distance that enables a manual rotational operation of the operation knob 29 on the top surface of the upper portion case 28 without being affected by the tank cover portion 28d. More specifically, it is a distance wide enough for the fingers holding the operation knob 29 to move in a space between the tank cover portion 28d and the outer circumferential portion.

In the configuration described above, as is shown in FIG. 6, the ribbon cassette shown in FIG. 3 is attached onto the carrier 32 on which the print head 31 is mounted. Print information is inputted into the printer shown in FIG. 5 and FIG. 6 from an unillustrated outside information device. Upon input of the print information, the printer activates the medium feeding mechanism, the carrier driving mechanism, and the print head describe above by the control portion, such as the printed circuit board, to print desired characters and figures on a medium subject to printing.

More specifically, the medium, such as a sheet of paper, is fed into a space between the print head 31 and the platen 39 by the medium feeding mechanism provided with the discharge roller 40 for a portion subject to printing to oppose the print head 31. The print head 31 activates the wire called the needle to protrude toward the platen 39 according to the print information, and causes the tip end thereof to collide on the medium via the ink ribbon 22 of the ribbon cassette 20 positioned at the print portion 20a. Dot-shaped printing is thus performed on the medium. Also, characters and figures according to the print information are printed on the medium as the carrier 32 moves in association with the operations of the print head 31.

During the printing operation, because the driving roller 23a rotates in a clockwise direction in the drawing in association with the movements of the carrier 32 in the ink ribbon 20, the endless ink ribbon 22 is circulated to move in a clockwise direction in the drawing along the length direction. A portion of the ink ribbon 22 used for printing in the print portion 20a (a portion from which ink has been transferred onto the medium) is fed to the ink replenishing mechanism 24 by passing through the arm portion 21c (the outbound path) shown in FIG. 4. Also, a portion of the ink ribbon 22 that has not been used for printing is fed to the print portion 20a by passing through the arm portion 21b (the inbound path) to prepare for the following printing.

Herein, because a tensile force is applied onto the endless ink ribbon 22 by the rotations of the driving roller 23a, the center of rotation of the transfer roller 26 is shifted to the left in the drawing by this tensile force, and the transfer roller 26 is pressed against the outer circumferential surface of the ink tank 25. Ink soaked through the ink tank 25 thus adheres onto the ink ribbon 26 that comes into contact with the outer circumferential surface of the transfer roller 26 to replenish the printed portion with ink via the transfer roller 26. In other words, in a normal state, the transfer roller 26 merely comes into contact with the outer circumstance of the ink tank 25, and does not replenish the ink ribbon 22 with ink. On the contrary, when the ink ribbon 22 is fed, the transfer roller 26 is pressed against the outer circumferential surface of the ink tank 25 by the tensile force of the ink ribbon 22 and replenishes the ink ribbon 22 with ink.

In short, the ink ribbon 22 is replenished with ink only when the ink ribbon 22 is circulated to move in association with the printing operation, and it is not replenished with ink in any other time. It is thus possible to prevent the ink ribbon 22 from being replenished with ink excessively. In addition, because a time for being pressed against the ink tank 25 is shorter than a case where it is kept pressed against the ink tank 25 constantly, it is possible to extend a time until the ink tank 25 undergoes deformation. A satisfactory printing state can be therefore maintained.

In the ribbon cassette 20 configured as above, the occurrence of the slack in the ink ribbon 22 before printing may possibly make satisfactory printing difficult. It is therefore necessary to take up the slack in the ink ribbon 22, for example, when the ribbon cassette 20 is attached onto the carrier 32. The slack in the ink ribbon 22 is thus taken up by rotating the operation knob 29 on the cover main body portion 28a by a manual operation to rotate the driving roller 23a in the feeding direction. In practice, the ink ribbon 22 is fed into the ribbon accommodating chamber 27 to confer the tensile force to the ink ribbon 22 other than the portion accommodated in the ribbon accommodation portion 27 to take up the slack particularly at the print portion 20a.

In this case, the operation knob 29 is provided on the outer circumference surface of the tank cover portion 28d in parallel with the tank cover portion 28d on the same cover top surface on the outer surface of the cover main body portion 28a. Nevertheless, because it is disposed with a sufficient distance from the outer circumferential surface of the tank cover portion 28d, it can be readily operated without any interference with its rotational operation. In addition, because there is no need to provide the operation knob above the tank cover as in the related art, there is a margin in a space above the tank cover 28d of the invention. Hence, a need to increase a tank capacity can be addressed without causing any problem by increasing the volume of the ink tank 25 by making the size of the ink tank 25 in the axial direction larger.

When the axial length of the driving roller 23a becomes longer, the driving roller 23a readily swings, and this swinging may possibly pose a problem in the feeding function of the ink ribbon 22. However, in this embodiment, because the operation knob 29 is provided directly on the top surface of the case main body portion 28sa, it is possible to shorten the rotational axis of the driving roller 23a. In other words, unlike a case in the related art where the operation knob is provided to stand upright on the top surface of the tank case portion, there is no need to increase the rotational axis of the driving roller more than a quantity comparable to the height of the tank case, and the driving roller 23a in this embodiment is able to drive the ink ribbon 22 to be fed in a stable manner without causing swinging. To be more concrete, it is preferable to make the height of the upper edge portion of the operation knob 29 on the case main body portion 28a nearly equal to the height of the top surface of the tank cover portion 28d or lower than the height of the top surface of the tank cover portion 28d.

What is claimed is:

1. A ribbon cassette, comprising:
a driving mechanism configured to nip an ink ribbon using a driving roller and a driven roller to move the ink ribbon in a length direction through rotations of the rollers;
an ink replenishing mechanism having a roller-shaped ink tank impregnated with ink and a transfer roller that comes into contact with an outer circumference of the ink tank and configured to replenish the ink ribbon coming into contact with the transfer roller with the ink soaked through the ink tank via the transfer roller;
a case configured to cover the driving mechanism and the ink replenishing mechanism and provided with a tank cover portion formed at a portion opposing the ink tank to swell in a similar figure; and
a take-up operation knob provided on an outer surface of the case with an interval large enough to enable an operation of the knob from an outer circumference of the tank cover portion and linked to the driving roller disposed within the case by penetrating through the case.

2. The ribbon cassette according to claim 1, wherein:
a tip end of the operation knob is set to a height nearly equal to a height of a top surface of the tank cover.

3. The ribbon cassette according to claim 1, wherein:
a tip end of the operation knob is set to a height lower than a height of a top surface of the tank cover.

4. A printer, comprising:
a ribbon cassette accommodating a driving mechanism configured to move an ink ribbon in a length direction and an ink replenishing mechanism having a roller-shaped ink tank impregnated with ink and a transfer roller that comes into contact with an outer circumference of the ink tank and configured to replenish the ink ribbon with the ink soaked through the ink tank via the transfer roller inside a case, a tank cover portion being formed on the case at a portion opposing the ink tank to swell in a similar figure, and a take-up operation knob being provided on an outer surface of the case with an interval large enough to enable an operation of the knob from an outer circumference of the tank cover portion and linked to the driving roller disposed within the case by penetrating through the case;
a carrier on which are mounted a print head to oppose a platen fixedly provided along a specific printing direction and the ribbon cassette for part of the ink ribbon to be positioned in a space between the print head and the platen, and which is configured to be able to reciprocate along a length direction of the platen; and
a medium feeding mechanism configured to feed a medium subject to printing into a space between the platen and the ink ribbon as well as the print head and then to move the medium in a direction orthogonal to a moving direction of the carrier in association with a movement of the carrier.

5. The printer according to claim 4, wherein:
a tip end of the operation knob provided on the outer surface of the case of the ribbon cassette is set to a height nearly equal to a height of a top surface of the tank cover.

6. The printer according to claim 4, wherein:
a tip end of the operation knob provided on the outer surface of the case of the ribbon cassette is set to a height lower than a height of a top surface of the tank cover.
